(19) United States
(12) Patent Application Publication
(10) Pub. No.: US 2020/0329079 A1
(43) Pub. Date: Oct. 15, 2020

(54) Interactive Presentation System and Method therefor

(71) Applicant: Inknoe Pte. Ltd., Woodlands Close (SG)

(72) Inventor: Yuanjun YAN, Sembawang (SG)

(21) Appl. No.: 16/402,178

(22) Filed: May 2, 2019

(30) Foreign Application Priority Data
Apr. 11, 2019 (SG) 10201903257Y

(51) Int. Cl. H04L 29/06; H04L 12/18; G06F 9/445; G06F 3/0482; G06F 3/0485

(52) U.S. Cl. CPC H04L 65/1089; H04L 65/4038; G06F 3/04855; G06F 9/44526; G06F 3/0482; H04L 12/1813

(57) ABSTRACT

The present invention provides a presentation system for interactive presentation session between a presenter user having a presentation device that include a presentation program and audience users having their own mobile devices. The presentation system comprises a presentation server hosted on a remote location, wherein the presentation is accessible by the presentation devices and the mobile devices through a communication network; a presenter client deployed on the presentation device as a plug-in of the presentation application, which is also embedded in a presentation file created by the presentation application, the presenter client comprises an audience input requestor and an analytic module; and a plurality of audience clients, operably connect to the presentation server and receive requests for inputs triggered from the presenter client. The audience input requestor is adapted to operatively broadcast the requests to the audience clients through the presentation server, whereby the users' input are collected by the presenter client for processing by the analytic module. A method therefor is also provided.

### FIELD OF THE INVENTION

The present invention relates to presentation system. Particularly, the present invention relates to a system and method for providing interactive presentations between presenter and audiences.

### BACKGROUND

Presentation software, such as Microsoft PowerPoint, has made creations of presentation slide easy and professionally. The presentation slides prepared through these software are noninteractive, and the slide contents cannot be changed during the presentation session.

There have since been various proposals offering interactive platforms adapted as replacement for the major presentation software such as, Microsoft PowerPoint, Apple Keynote, or the like. These presentation systems may offer some good features, users are required to adapt the new system for that new features of interest. The learning curve is usually steep, and often, users gave up the new good features, and returned to the major presenter software.

### SUMMARY

In one aspect of the present invention, there is provided a presentation system for interactive presentation session between a presenter user having a presentation device that include a presentation program and audience users having their own mobile device. The presentation system comprises a presentation server hosted on a remote location, wherein the presentation is accessible by the presentation devices and the mobile devices through a communication network; a presenter client deployed on the presentation device as a plug-in of the presentation application, which is also embedded in a presentation file created by the presentation application, the presenter client comprises an audience input requestor and an analytic module; and a plurality of audience clients, operably connect to the presentation server and receive requests for inputs triggered from the presenter client. The audience input requestor is adapted to operatively broadcast the requests to the audience clients through the presentation server, whereby the users' input are collected by the presenter client for processing by the analytic module.

In one embodiment, the presenter client further comprises an annotation module adapted for allowing user annotations over presenting slides. The annotation module comprises a tool bar on the presenting slides in an alternative embodiment.

In a further embodiment, the presenter client further comprises a digital black/white board. The presentation application is Microsoft PowerPoint.

In another embodiment, the requests include request for voting. The presentation system further comprises a remote device operatively accessing the presentation server for receiving the presentation session as the local attendees.

In another aspect, there is also provided a presenter client adapted for the aforesaid presentation system.

A method of facilitating an interactive presentation session between a presenter user having a presentation device that include a presentation program and audience users having their own mobile device. The method comprises deploying a remote presentation server, a presenter client on the presentation device and a plurality of audience clients on audience users' mobile devices, wherein the presentation device and the mobile devices are accessible to the remote presentation server via a communication network, wherein the presentation client is deployed on the presentation device as a plug-in of the presentation application, which is also embedded in a presentation file created by the presentation program; broadcasting requests to audience clients through the presentation server; collecting responses from the audience users; analyzing the responses; and presenting the analyzed results to the audience users during the presentation session.

In one embodiment, the presentation program is Microsoft PowerPoint.

### BRIEF DESCRIPTION OF THE DRAWINGS

This invention will be described by way of non-limiting embodiments of the present invention, with reference to the accompanying drawings, in which:

FIG. 1 illustrates a schematic diagram of the presentation system in accordance with an embodiment of the present invention;

FIG. 2 illustrates a block diagram of a presenter client and audience client in accordance with an embodiment of the present invention;

FIGS. 3A-3D exemplify screenshots of the features of the presentation system in accordance with embodiments of the present invention;

FIGS. 4A and 4B illustrates an audience input request system in accordance with an embodiment of the present invention; and

FIG. 5 exemplifies schematically a presenter screen according to an embodiment of the present invention.

### DETAILED DESCRIPTION

In line with the above summary, the following description of a number of specific and alternative embodiments are provided to understand the inventive features of the present invention. It shall be apparent to one skilled in the art, however that this invention may be practiced without such specific details. Some of the details may not be described at length so as not to obscure the invention. For ease of reference, common reference numerals will be used throughout the figures when referring to the same or similar features common to the figures.

The present application discloses the client on the host presenter side is an add-in to the major presentation systems, whereby the clients on the audience users are add-on apps as standalone application module for deploying on their mobile devices. In this application, “add-in”, aka plug-in, refers to an application module adapted to deploy over any existing software application as integral part thereof to offers the additional functionality and features.

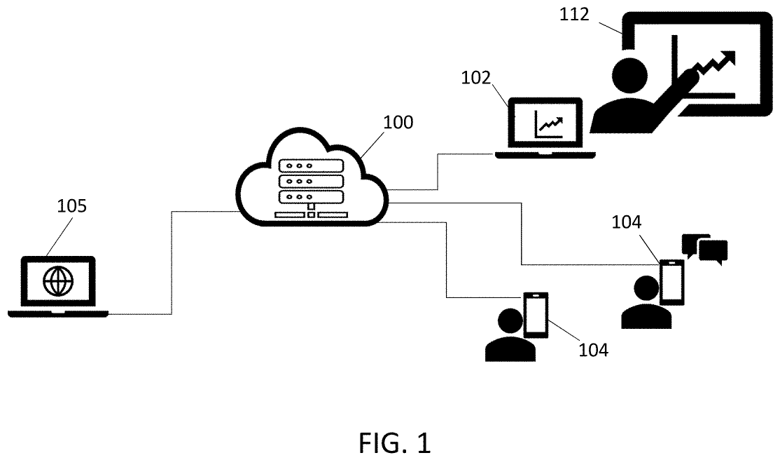

FIG. 1 illustrates a schematic diagram of the presentation system in accordance with an embodiment of the present invention. The presentation system comprises a presentation network server 100 and presentation clients 102, 104 deploying on the respective user devices, whereby the clients 102, 104 operationally connected to the presentation network server 100 via a communication network. In the present embodiment, the presentation network server 100 may be a cloud server hosting the services offer by the presentation system. In another embodiment, the presentation system can be hosted on a dedicated server assessible through the communication network.

As shown in FIG. 1, the presentation client 102 can be deployed on a computer operable by a presenter user. The computer has a presentation software installed thereon. The computer may be connected to a large display unit 112 for displaying the presentation slides. Preferably, the large display unit is touch responsive operably feedback to the computer in response to the interaction between the presenter user and the projected screen. In one embodiment, the large display unit is a large panel touch sensitive display panel. In another embodiment, the large display unit may be a interactive projector unit.

For purpose of illustrations, not limitations, the presentation software is Microsoft PowerPoint (or simply PowerPoint), and the presentation client 102 is deployed as an add-in or plug-in of the PowerPoint constructed using Visual Studio Tools for Office. The presenter user of the PowerPoint may use the software to create presentation slides and store a copy of the file on the computer. The presentation client 102 is operable when the PowerPoint is executed during a presentation session.

The presentation clients 104 are individually deployed on the audience users' personal communication devices as independent application module or app offering a Bring Your Own Device (BYOD) presentation session. In general, the audience users are already present at the venue where the presentation is carried out, and the users' personal communication devices usually comprises small screen size. Therefore, the presentation clients 104 are not intended to mirror the presentation slides, instead, it provides features allowing the audience users to interact with the presenter user during the presentation.

In one embodiment, a remote terminal 105 may access the presentation network server 100 to join the presentation interactively and remotely.

The presentation client 102 allows the presentation session to be conducted more interactively with the audiences through the presentation client 104. Specifically, the clients offer several useful features which include, annotations, a digital white/black board, a BYOD interactor and an analytic means.

In one embodiment, the computer is an all in one computer with integrated touch display system.

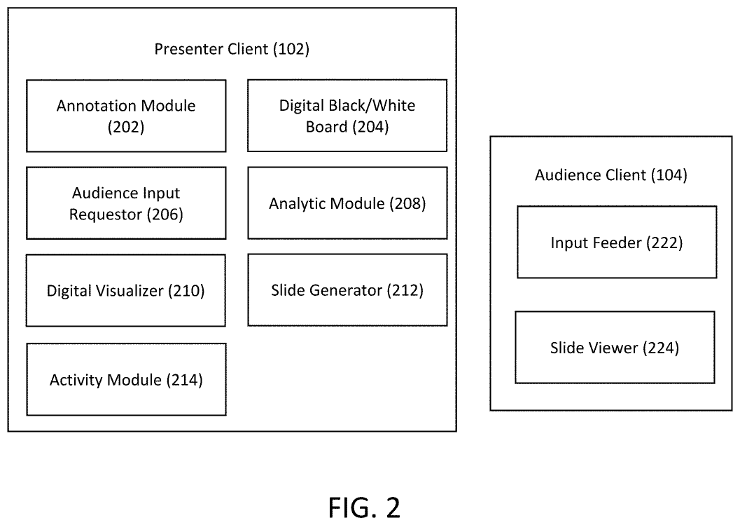

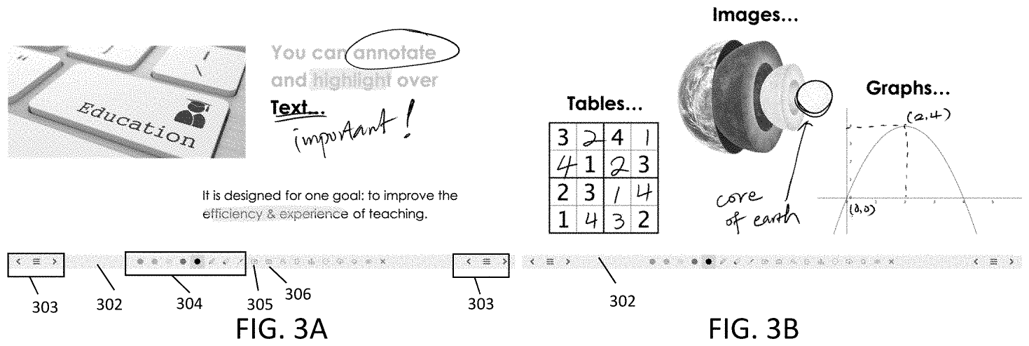

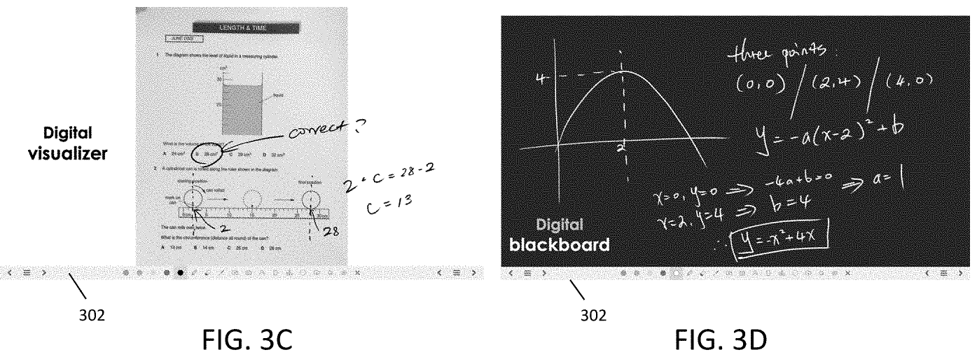

FIG. 2 illustrates a block diagram of the presenter client 102 and audience client 104 in accordance with an embodiment of the present invention. FIG. 3A-3D exemplify some screenshots of the presentation slides of embodiments of the present invention. The presenter client 102 comprises a annotation module 202, a digital white/black board 204, an audience input requestor 206, an analytic module 208, Digital Visualizer 210, a slide generator 212, and an activity module 214. The presenter client 102, once added to a presentation slide, is embedded to in the saved file. There features offered by the respective modules can be triggered anytime during the presentation sessions, by way of elements of a tool bar 302 (see FIG. 3A) available on the presentation slides. The tool bar 302 can be shown along with the slide whenever the slide is in “slide show” mode. In an alternative embodiment, the toolbar 302 can “auto-hide” when desired.

The toolbar 302 offers graphical control elements on-screen to trigger functions of the presentation system. At two ends of the toolbar 302 includes slides control elements 303 wherein a previous and next slide button allows the presenter to control flip between the next/previous slides. The slide control elements 303 may also include a slide index button allowing the presenter to navigate to any desired slide at ease.

Returning to FIG. 2, the annotation module 202 is adapted to allow presenter user to make annotations over the slides as shown in FIGS. 3A and 3B. The tool bar 302 offers annotations elements 304 for selecting pre-set colours of the annotations, weight of the lines, types of annotation (such as pens, highlights, etc.), eraser and etc. It allow presenter to perform manuscript over the slides through human gestures or with aid of external devices under the slide show mode. The illustrated figures are presented in black and white color without any limitations. It is understood to a skilled person that the the pens, highlights can be selected in various colors.

In one embodiment, the annotations can be applied on the presentation slide on a layer on top. The annotations can be added literally anywhere on the presentation slides, including table, images, graphs, etc. as shown in FIG. 3B. The annotations does not affect the presentation slides that are originally prepared. Through the annotation module 202, presenter user can effectively conduct the presentation session more interactively.

In one embodiment, the annotation module 202 includes a trigger that executes an integrated annotation feature of a presentation program. Typically, annotation feature is hidden under the slide show mode. In this case, the annotation module 202 provides a user interface to conveniently allowing the user to select the desired stationaries.

In a further embodiment, the annotation module 202 may auto-save the slides with the annotations made by the presenter during the presentation session. In yet another embodiment, the annotation module 202 may be adapted to save the annotated slide as a new slide. The new slide can be added to the original presentation file as additional slide.

The digital white/black board 203 features a virtual writing board that presenter user may write freely over a provided white/black space, through user's hand gesture or other means over the display. In an alternative embodiment, the annotation may also be achieved through a separate device, such as a digital drawing tablet, a computer drawing pad/board, a digital stylus pen or the like.

The digital white/black board 203 is adapted to work in conjunctions with the annotation module 202, whereby the digital white/black board 203 inserts a new slides with either black or white background, and the annotation module 202 allows the presenter to scribble on black or white background.

In one embodiment, the white/black board 203 is infinite in size, which can be zoomed (in or out), and scroll when needed.

The digital white/black board 203 can be launched by a white/board board element 305 on the toolbar 302. The black/white board 203 is desirably launch together with the annotation module offering the presenter a full control over the colors, pen types and etc. when scribbling on the virtual black/white board space.

Similarly, the digital white/black board 203 may allow presenter to save the annotated screen. The screen can be saved as a slide of the presenting slide file.

The toolbar 302 includes a camera trigger 306 to launch the digital visualizer 210. The digital visualizer 210 usually require the presenter device be connected to an overhead camera. The overhead camera is well know in the art. With the the digital visualizer 210 add-on in the presentation, presenter does not need to switch projector's source between the presentation device and the overhead camera. Further, the digital visualizer 210 allows the presenter to capture images through the overhead camera. In an alternative embodiment, the captured images can be inserted as slides in the presenting slide file as shown in FIG. 3C.

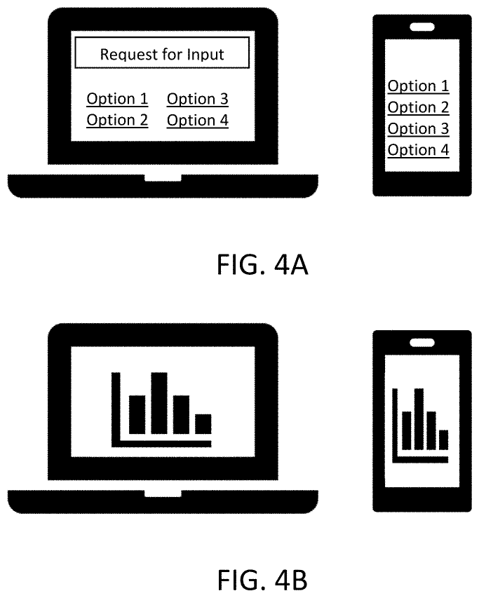

The audience response requester 206 is a means for requesting audiences' inputs, such as votes, or selections. The audience response requester 206 include a module provided for presenter user to prepare an audience input template. The audience input template can be embedded within file of the presentation slides, and when triggered, the requester 206 display the same on screen as shown on FIG. 4A and transmits the same to the presentation server 100, whereby the audience users who assess the presentation session operationally receive the prompt for their contributions through BYOD. With the devices of the audiences that are deployed with the audience client 104 that include an input feeder 222, the presentation server 100 broadcast the requests to the audiences for their inputs. Typically, the inputs from the audiences are selectable from a list of selections. The list is then displayed on the audiences' devices as shown in FIG. 4A and prompt user to select them. A time period may be set by the audience input requestor 206 for audience response, and once expires, no further inputs shall be accepted, and the audience input requestor 206 gathers the inputs for processing by the analytic module 208. When desire, the presenter user may choose to present the processed data to the audiences as shown in FIG. 4B. The output of the analytic module 208 may be in a form of graphs, charts of the like.

In one embodiment, The audience input requestor 206 may include audience manager. The audience manager is adapted to control audiences participations to a presentation session. Presenter may invite audiences to join the presentation session, view the joined audiences, remove unwanted participants, etc. The audience manager may generate a QR code to display on a projected screen, whereby audiences may scan the QR code for accessing the presentation session with their own mobile device. Presenter may also choose to use URL address for participating the presentation system.

The presenter client 102 may further provide a slide generator 212 that broadcast the slides to slide viewers 224 of the Audience Client 104 on audiences' devices. The slide generator 212 may offer three viewing modes: Follow-along mode, self-paced mode, and title slides only mode. The follow-along mode livestreams the slides that are currently used. The self-paced mode allows audiences to navigate and select a slide to be shown at their will. The title slides only mode only broadcast the title slide only, so that audiences can focus on the presenter. In one embodiment, the viewing mode can be set by the presenter client 102 only.

Returning to FIG. 2, the activity module 214 is adapted to interact with the audiences more through acquiring audiences inputs. The activity module 214 may opened up channels for receiving audiences' live feeds/comments, rendering word clouds based on user inputs, receiving audiences' image upload, audience picker, etc. for aiding the interactive presentation session.

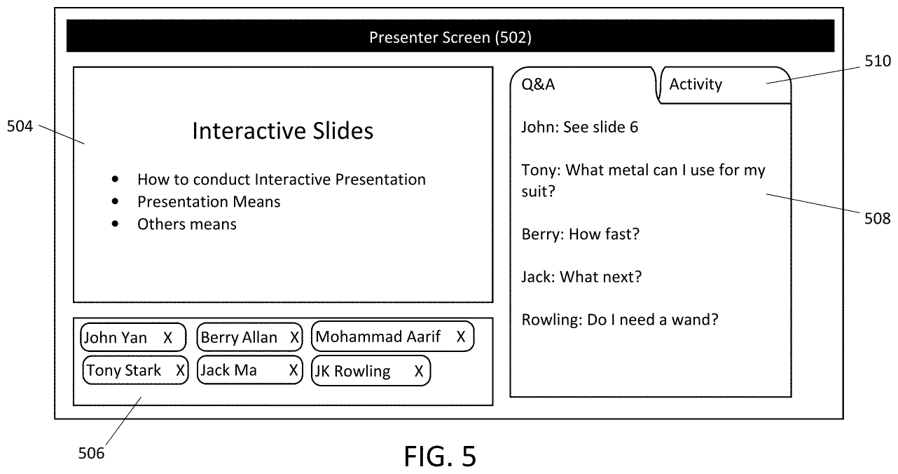

FIG. 5 illustrates schematically a presenter screen 502 according to an embodiment of the present invention. The presenter screen 502 does not mirror the projected screen, or the presenting screen 112. According to an embodiment of the present invention, when the presentation file is executed, only the projected screen or presenting screen 502 shows the presenting slide 504, whereby the presenter device 102 may show a presenter view 502 that present additional information not available on the slides. For example, the presenter view 502 may provide audience list pane 506, Q&A tab 508 and activity tab 510. The audience list pane 506 allows presenter to view who are the participated audiences, and remove them easily with one-click on the “X” sign. The Q&A tab 508 shows the comments pane that live feed with user input comments. The activity tab 510 offers controls over the activity module.

While specific embodiments have been described and illustrated, it is understood that many changes, modifications, variations and combinations thereof could be made to the present invention without departing from the scope of the invention.

1. A presentation system for interactive presentation session between a presenter user having a presentation device that includes a presentation program and audience users having their own mobile devices, the presentation system comprising:
a presentation server hosted on a remote location, wherein presentation is accessible by the presentation devices and the mobile devices through a communication network;
a presenter client deployed on the presentation device as a plug-in of the presentation application, which is also embedded in a presentation file created by the presentation application, wherein the presenter client comprises an audience input requestor and an analytic module; and
a plurality of audience clients deployed on the mobile devices, operably connect to the presentation server and receive requests for inputs triggered from the presenter client,
wherein the audience input requestor is adapted to operatively broadcast the requests to the audience clients through the presentation server, whereby the users' inputs are collected by the presenter client for processing by the analytic module.

2. The presentation system according to claim 1, wherein the presenter client further comprises an annotation module adapted for allowing user annotations over presenting slides.

3. The presentation system according to claim 2, wherein the annotation module comprises a tool bar on the presenting slides.

4. The presentation system according to claim 1, wherein the presenter client further comprises a digital black/white board.

5. The presentation system according to claim 1, wherein the presentation application is Microsoft PowerPoint.

6. The presentation system according to claim 1, wherein the requests include request for voting.

7. The presentation system according to claim 1, further comprising a remote device operatively accessing the presentation server for receiving the presentation session as the local attendees.

8. A presenter client for a presentation system according to claim 1.

9. A method of facilitating an interactive presentation session between a presenter user having a presentation device that includes a presentation program and audience users having their own mobile devices, the method comprising:
deploying a remote presentation server, a presenter client on the presentation device and a plurality of audience clients on audience users' mobile devices, wherein the presentation device and the mobile devices are accessible to the remote presentation server via a communication network, wherein the presentation client is deployed on the presentation device as a plug-in of the presentation application, which is also embedded in a presentation file created by the presentation program;
broadcasting requests to audience clients through the presentation server;
collecting responses from the audience users;
analyzing the responses; and
presenting the analyzed results to the audience users during the presentation session.

10. The method according to claim 0, wherein the presentation program is Microsoft PowerPoint.
